(19) United States
(12) Patent Application Publication
(10) Pub. No.: US 2009/0320123 A1
(43) Pub. Date: Dec. 24, 2009

(54) METHOD AND APPARATUS FOR USER RECOGNITION EMPLOYING MOTION PASSWORDS

(75) Inventors: Yang YU, San Jose, CA (US); Bogdan O. Carbunar, Palatine, IL (US); Zhu Li, Palatine, IL (US); Weidong Shi, Windson, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 12/142,967

(22) Filed: Jun. 20, 2008

(51) Int. Cl. H04L 9/32; G06F 3/033

(52) U.S. Cl. 726/16; 715/863

(57) ABSTRACT

A method and apparatus are disclosed that authenticate a user of a mobile device with motion sensors. During a learning session, the user initializes the mobile device by providing a motion sample. The mobile device extracts motion features that are unique to the user and converts them to parity bits and to a password shadow. During a recognition session, a motion pattern is gathered from the user moving the mobile device as if it were a virtual pen. The mobile device then uses the stored parity bits to correct small differences between motion patterns exhibited by the same user at different times. The mobile device converts the corrected motion pattern into a motion password that is compared with the stored password shadow. A user is authenticated only if the two values coincide. The system erases the generated motion password.

### BACKGROUND OF THE INVENTION

1. Field of the Invention

The invention relates to user recognition for granting access or service to authorized users, and, more particularly, to verifying both the identity and presence of a mobile user.

2. Introduction

Mobile applications and services including mobile commerce, banking, and blogging or messaging often require authentication of the mobile user accessing them. However, the physical constraints specific to mobile devices make the use of traditional authentication mechanisms a cumbersome operation.

Currently, there are several techniques and apparatus for authenticating a user. These techniques have been significantly implemented in systems which verify the identity of an individual requesting access to a service or facility (device) in order to determine if in fact the individual is authorized to access the service or facility. In such situations, users typically have to write down, type or key in certain information in order to send an order, make a request, obtain a service, use a device, perform a transaction, or transmit a message.

Verification or authentication of users prior to obtaining access to such services or facilities typically relies essentially on the knowledge of passwords or personal identification numbers (PINs). However, such conventional user verification techniques present many drawbacks. First, perpetrators intent on committing fraud can usually decipher user selected passwords and PINs fairly easily. Additionally, advances in technology have made it easier for a perpetrator to fraudulently obtain a password or PIN. Similarly, user verification techniques employing items such as keys, ID cards, and ID cards with embedded PINs also present many drawbacks. Some computing devices utilize motion as an interface to authorize a user.

The patent to Marvit et al., U.S. Pat. No. 7,173,604B2, describes a system and method for matching a gesture against a gesture mapping database comprising a set of command maps where each map correlates an input gesture to a command that can be used to control the operation of a particular controllable device. A major drawback of the Marvit et. al. patent is that storage of information for a gesture database and gesture recognition is not secure and does not preserve the privacy of a user.

### SUMMARY

A method that authenticates a user of a mobile device is disclosed. The apparatus may include motion sensors integrated with mobile devices to provide an efficient and secure mechanisms for user authentication. The user's motion patterns can be extracted from data captured by the motion sensors and then used as part of the authentication protocol. During a learning session, the user initializes the mobile device by providing a motion sample. The mobile device extracts motion features that are unique to the user and converts them to parity bits and to a password shadow. During a recognition session, the user is authenticated with the device by providing a motion pattern that is then error corrected with the stored parity bits and compared with the stored password shadow. The motion pattern results from the user moving the mobile device as if it were a virtual pen. That is, the user holds the device and writes with it “on the air,” either a predetermined password or a challenge displayed on the mobile device's screen. The mobile device then uses the stored parity bits to correct small differences between motion patterns exhibited by the same user at different times. The mobile device converts the corrected motion pattern into a motion password that is compared with the stored password shadow. A user is authenticated only if the two values coincide. The system erases the generated motion password.

### BRIEF DESCRIPTION OF THE DRAWINGS

FIG. 1 is an exemplary diagram that illustrates a network environment in accordance with a possible embodiment of the invention;

FIG. 2 is an exemplary diagram that illustrates a mobile communication device in accordance with a possible embodiment of the invention;

FIG. 3 is a flowchart showing processing performed at a mobile device to authenticate a user in accordance with a possible embodiment of the invention;

FIG. 4 is a flowchart of post processing performed at a mobile device after a user has been authenticated in accordance with a possible embodiment of the invention;

FIG. 5 is a flowchart showing processing performed at a mobile device to generate a motion password shadow and to generate motion password parity bits in accordance with a possible embodiment of the invention;

FIG. 6 is a flowchart showing generation of a motion password from extracted and corrected motion features in accordance with a possible embodiment of the invention;

FIG. 7 is a flowchart showing processing performed at a mobile device to verify a user in accordance with a possible embodiment of the invention; and

FIG. 8 is a flowchart showing processing performed at a mobile device to provide biometric hardened password verification in accordance with a possible embodiment of the invention.

### DETAILED DESCRIPTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

The invention concerns the use of motion sensors such as accelerometers, gyros, and tilt sensors, integrated with mobile devices, to enable simple, efficient, and secure mechanisms for user authentication. The invention employs the unique motion patterns of a user. The user's motion patterns can be extracted from data captured by the motion sensors and then used as part of the authentication protocol.

The user recognition algorithm consists of an initialization phase learning session) and a verification phase (recognition session). In the initialization phase, the user initializes the mobile device by providing a movement sample. The system uses the sample to extract motion features that are unique to the user and converts them to a motion password. From the motion password the system extracts error correcting bits (parity bits) and stores them, along with a one-way summary of the motion password (password shadow) on the mobile device. The mobile device then erases the motion password.

In the verification phase, the user authenticates with the device by comparing the user's motion patterns with the information stored on the mobile device during the initialization phase. For this, the user is asked to move the mobile device as if it were a virtual pen. That is, the user holds the mobile device and writes with it “on the air,” either a predetermined password or a challenge displayed on the phone's screen. Similar to the initialization phase, the mobile device uses the motion sample provided by the user in order to extract motion features. The mobile device then uses the parity bits stored on the device in order to correct small differences between motion features exhibited by the same user at different times. The mobile device converts the corrected motion features into a motion password and compares its one-way summary to the password shadow stored on the mobile device. A user is authenticated only if the two values coincide. The mobile device erases the generated motion password to prevent copying by an unauthorized entity.

Besides applying the described technique directly to mobile devices, an extension of this technique can be envisioned, where the motion features are captured using accessories that are connected to the mobile device via wired or wireless connection. Instances include but are not limited to a Bluetooth pen or mouse. In the case where the raw motion data has to be transmitted between the accessories and the mobile device, encryption needs to be employed to provide secure data transmission. The user-recognition apparatus preserves the privacy and security of the device even when an attacker has complete access to the content stored on the device, including the summary and parity bits of the motion password. In the case where accessories are used for motion features capturing, encryption needs to be used to preserve the confidentiality of the feature transmission.

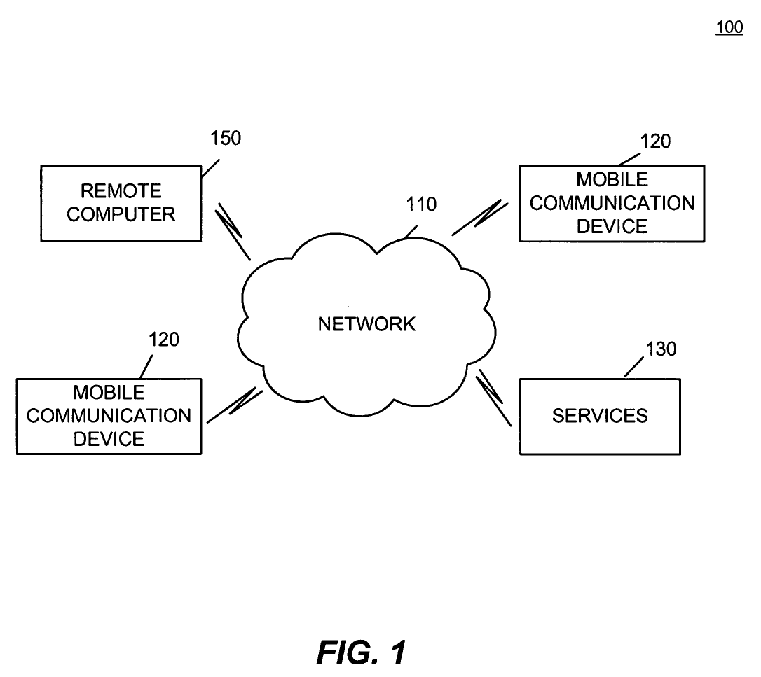

FIG. 1 is an exemplary diagram that illustrates a network environment 100 in accordance with a possible embodiment of the invention. In particular, the network environment 100 may include a plurality of mobile communication devices 120, a service 130 provided by a content service provider, and remote computer 150 all connected via network 110. Network 110 includes but is not limited to 2-4G, Internet, Ethernet, WiFi, and Bluetooth networks.

The mobile communication device 120 may be a portable MP2 player, satellite radio receiver, AM/FM radio receiver, satellite television, portable music player, portable computer, wireless radio, wireless telephone, portable digital video recorder, handheld device, cellular telephone, mobile telephone, mobile device, personal digital assistant PDA), or combinations of the above, for example.

Remote computer 150 includes an operating system (not shown) that is stored in a computer-accessible media RAM, ROM, and mass storage device, and is executed by a processor. Examples of operating systems include Microsoft Windows®, Apple MacOS®, Unux®, and UNIX®. Examples are not limited to any particular operating system, however, and the construction and use of such operating systems are well known within the art. Embodiments of remote computer 150 are not limited to any type of computer. In varying embodiments, remote computer 150 comprises a PC-compatible computer, a MacOS®-compatible computer, a Linux®-compatible computer, or a UNIX®-compatible computer. The construction and operation of such computers are well known within the art.

A mobile device such as mobile communication device 120 can further include a transceiver to access one or more services 130 over network 110. A service often requires user authentication. Instances of considered services 130 include mobile commerce, banking, blogging, teleconferencing, email, or any other mobile Internet based services. In one case, access to the mobile device itself can be considered as a service such as when a user locks the phone and later only an authenticated user can unlock the mobile device.

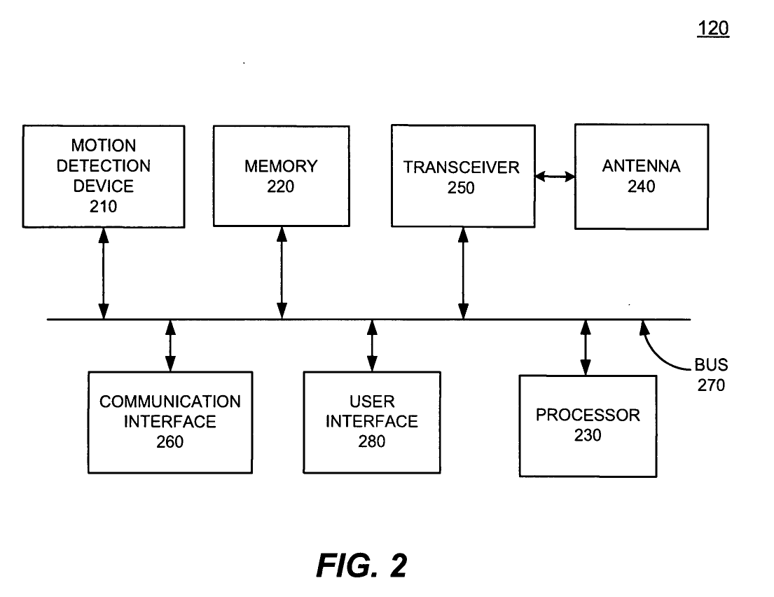

The network environment 100 illustrated in FIG. 1 and the related discussion are intended to provide a brief, general description of a suitable computing environment in which the invention may be implemented. Although not required, the invention will be described, at least in part, in the general context of computer-executable instructions such as program modules, computer program embodied in a computer readable medium and operable when executed to perform steps, being executed by the mobile communication device 120. Generally, program modules include routine programs, objects, components, data structures, and the like that perform particular tasks or implement particular abstract data types. Moreover, those skilled in the art will appreciate that other embodiments of the invention may be practiced in communication network environments with many types of communication equipment and computer system configurations which operate from batteries, including cellular network devices, mobile communication devices, portable computers, hand-held devices, portable multi-processor systems, microprocessor-based or programmable consumer electronics, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices. The mobile communication device 120 is described further below in relation to FIG. 2.

FIG. 2 is an exemplary diagram that illustrates a mobile communication device 120 in accordance with a possible embodiment of the invention. The mobile communications device 120 may include a bus 270, a processor 230, a memory 220, an antenna 240, a transceiver 250, a communication interface 260, a motion detection device 210, and a user interface 280. Bus 270 may permit communication among the components of the mobile communication device 120.

Motion detection device 210 can comprise one or more accelerometers, gyros, inclinometers, cameras, tilt sensors, or any other sensors that can determine the motion of a device within N degrees of freedom, with N being an integer greater than or equal to one but less than or equal to six. The mobile device will be subjected to movements that will cause it to roll, pitch, and yaw like an airplane in flight. For example, in six degrees of freedom one can use six vectors in the spatial domain over the smoothed curve points: (1) x horizontal coordinates; (2) y vertical coordinates; (3) s path distance from the origin; (4) theta angle of the path tangent at the point with the x-axis; (5) c curvature; (6) Delta_c derivative of curvature along a respective axis such as x, y, or z In the temporal domain vectors calculated from the original motion data points such as horizontal velocity, vertical velocity, tangential velocity, tangential acceleration, and angular velocity can be used for motion detection. Accelerometers detect movement of the device by detecting acceleration along a respective sensing axis such as x, y, and z. A movement pattern may comprise a series, sequence, or pattern of accelerations detected by the accelerometers. When the handheld device is tilted along a sensing axis of a particular accelerometer, the gravitational acceleration along the sensing axis changes. This change in gravitational acceleration is detected by the accelerometer and reflects the tilt of the device. Similarly, translation of the handheld device, or movement of the device without rotation or tilt also produces a change in acceleration along a sensing axis which is also detected by the accelerometers. Accelerometers, gyros, or tilt sensors can be used to measure translation or tilting of the device within a given coordinate structure. The output of the motion detection device 210 can be processed by processor 230 with instructions in memory 220 to extract features from the movement of the mobile device to verify both the identity and presence of a mobile user.

Processor 230 may include at least one conventional processor or microprocessor that interprets and executes instructions. Memory 220 may be a random access memory (RAM) or another type of dynamic storage device that stores information and instructions for execution by processor 230. Memory 220 may also include a read-only memory ROM) which may include a conventional ROM device or another type of static storage device that stores static information and instructions for processor 230. Transceiver 250 may include one or more transmitters and receivers. The transceiver 250 may include sufficient functionality to interface with any network or communications station and may be defined by hardware or software in any manner known to one of skill in the art. The processor 230 is cooperatively operable with the transceiver 250 to support operations within the communications network 110. The transceiver 250 transmits and receives transmissions via one or more antennae 240 in a manner known to those of skill in the art.

Communication interface 260 may include any mechanism that facilitates communication via network 110. For example, communication interface 260 may include a modem. Alternatively, communication interface 260 may include other mechanisms for assisting the transceiver 250 in communicating with other devices or systems via wireless connections. User interface 280 may include one or more conventional input mechanisms that permit a user to input information, communicate with the mobile communication device 120, and present information to the user, such as an electronic display, microphone, touchpad, keypad, keyboard, mouse, pen, stylus, voice recognition device, buttons, one or more speakers.

The mobile communication device 120 may perform with processor 230 input, output, communication, programmed, and user-recognition functions by executing sequences of instructions contained in a computer-readable medium, such as, for example, memory 220. Such sequences of instructions may be read into memory 220 from another computer-readable medium, such as a storage device, or from a separate device via communication interface 260.

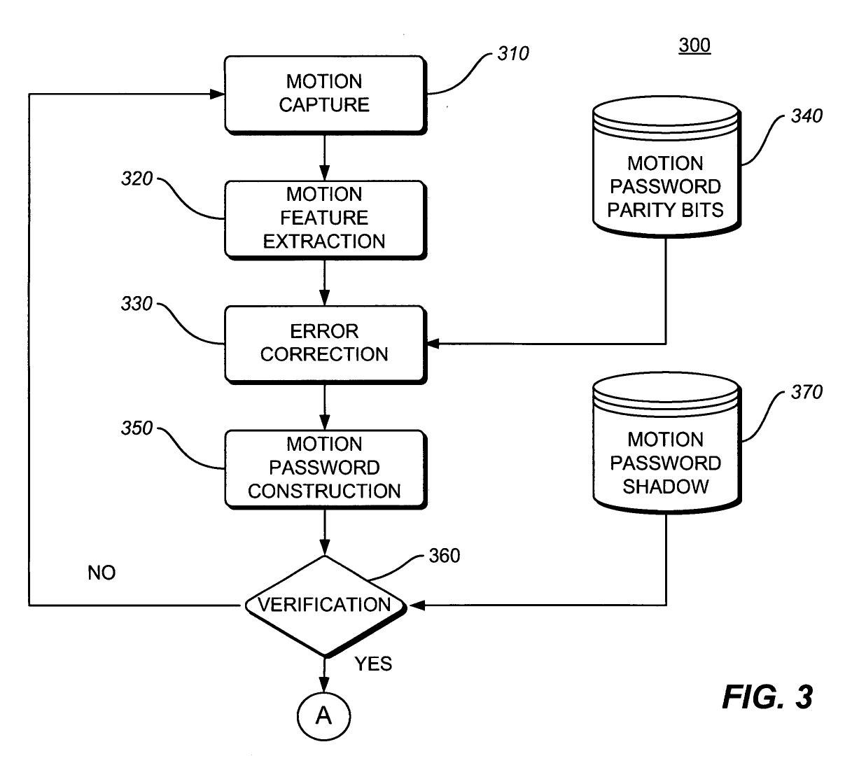

FIG. 3 is an exemplary flowchart illustrating some of the basic steps associated with a process for authenticating during a recognition session a user in accordance with a possible embodiment of the invention.

In action 310, a user subjects a device such as mobile communication device 120 to a series of movements so as to provide a movement sample. The user could be asked to move the device as if it were a virtual pen. That is, the user holds the device and writes with it “on the air,” either a predetermined password or a challenge displayed on the phone's screen. A user could trace letters, digits, or pictorial symbol sequences in the air, with the mobile device. As noted above the motion capture produces signals that reflect motion of the device within N degrees of freedom, with N being an integer greater than or equal to one but less than or equal to six. The captured motion could be a selected segment of the motion password for the particular user. Once the motion has been captured in action 310 control passes to action 320 for further processing.

In action 320, the captured motion is subjected to motion feature extraction. Motion feature extraction is based on the spatial and temporal vectors of the captured motion. The vectors can be statistically analyzed and values can be computed per vector to find the average, standard deviation, minimum and maximum of the speed, deviation, positive angle and negative angle of the captured motion. After completing motion feature extraction control passes to action 330 for further processing.

In action 330, the motion feature extraction data produced in action 320 are error corrected. Error correction is important at this juncture because a small difference in the motion feature will produce a significant difference in the output. To accomplish error correction, the errors occurring in the extracted motion are combined with motion password parity bits 340 captured in a learning session.

In action 350, the error corrected extracted motion features are used to construct a motion password. The constructed motion password is a one-way summary of the motion captured in action 310. A one-way summary is a one-way-function that is easy to compute but exceedingly difficult to invert. A one-way function is sometimes called a trapdoor function. The extracted motion features are passed through the one-way function with fuzzy vaults based on error-correcting codes, such as Solomon-Reed, to construct the one-way summary.

In action 360, verification is made to determine if the motion password matches the motion password for the user of the mobile communication device. The motion password for the user of the mobile communication device is maintained as a motion password shadow 370. The motion password shadow 370 is a one-way summary of the motion password from motion captured in a learning session. The constructed motion password from action 350 is verified against the motion password shadow 370. If the verification does not result in a match control is returned to action 310 where the user is prompted to enter a motion sequence. If the verification indicates a match control is passed to an action for further processing.

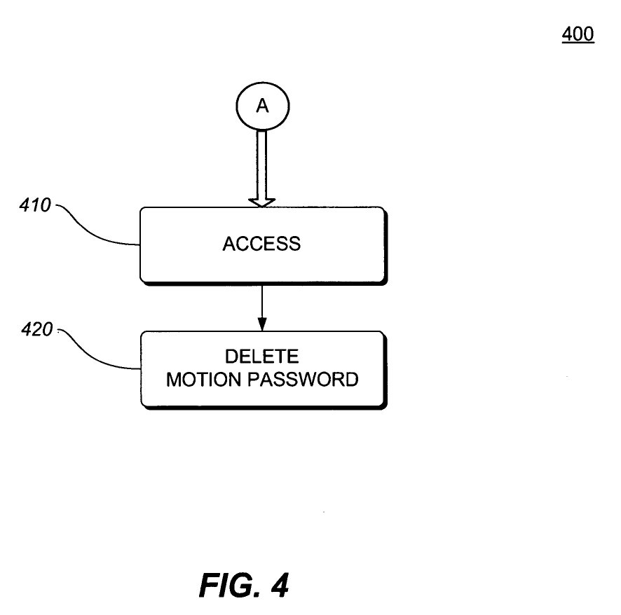

FIG. 4 is a flowchart of method 400 which performs post processing after a user has been authenticated (method 300) in accordance with a possible embodiment of the invention. If the user is verified control passes to action 410 for further processing. In action 410 access to the service or device is granted. Access includes providing admission to mobile internet services, mobile banking or e-commerce, usage of the mobile communication device 120, usage of selected services or software in the device, or right to use selected hardware resources. Once access has been granted the motion password constructed in action 350 is deleted in action 420. Deleting the constructed motion password when access is granted prevents the copying of the motion password by another user.

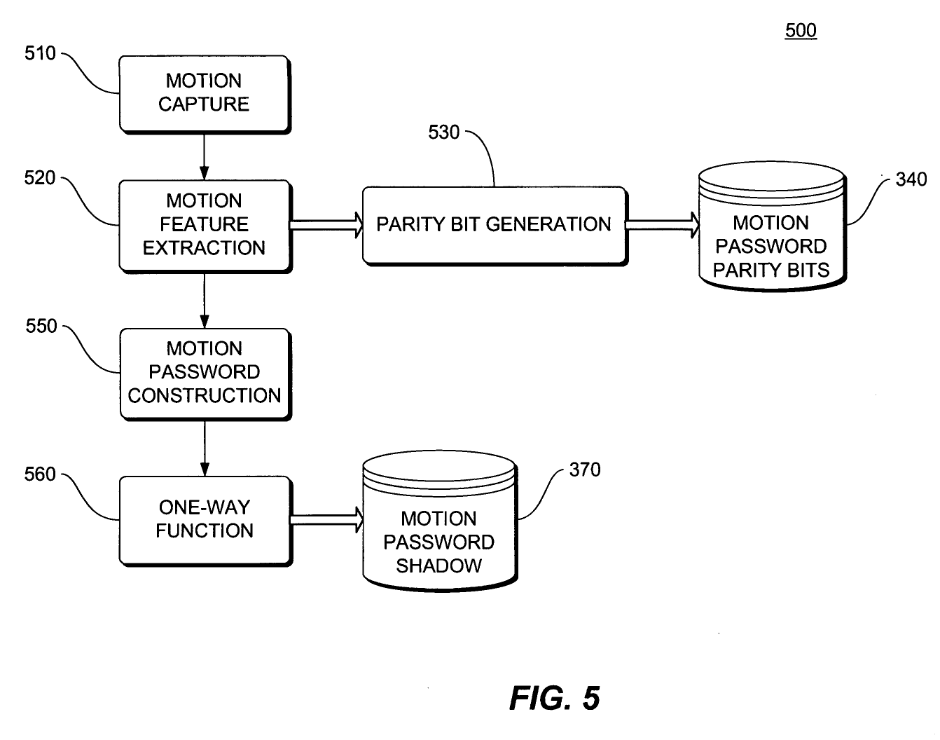

FIG. 5 is a flowchart of method 500 performed during a learning session to generate a motion password shadow and to generate motion password parity bits in accordance with a possible embodiment of the invention.

Method 500 begins with action 510 where motion is captured. The capture motion produces signals that reflect motion of the device within N degrees of freedom, with N being an integer greater than or equal to one but less than or equal to six. The signals are traces from accelerometers, tilt sensors, or gyro sensors that represent motion of a device along a particular dimension. The user of the mobile communication device can select a motion writing or a motion drawing to represent the password that will grant access to a device or service. The difference between motion writing and motion drawing is the content. When what is drawn by a mobile communication device 120 user includes a sequence of digits and letters, it is motion writing, otherwise it is motion drawing. In action 520, the capture motion is processed to extract motion features. Motion feature extraction is based on the spatial and temporal vectors of the captured motion. The vectors can be statistically analyzed and values can be computed per vector to find the average, standard deviation, minimum and maximum of the speed, deviation, positive angle and negative angle of the captured motion. The extracted motion features are then transformed by parity bit generation 530 to a series of codes. The generation of the parity bits can be done by using well known techniques like BCH coding or Solomon-Reed coding. Input data are sampled and evaluated by a generator polynomial to create several check parity bits. The parity bits allow for the evaluation of data and allow for the correction of any data bits that were corrupted. The parity bits 340 are stored as motion password parity bits to authenticate a user during a recognition session. In action 550, the extracted motion features are used to construct a motion password. The features are statistically analyzed to derived values such as minimums, maximums, means, standard deviation, range, and other attributes for each degree of freedom. Thus, every domain of the captured motion is represented as vector that describes the motion password for the particular user. In action 560, a one-way function is used to process the constructed motion password. The one-way function takes the constructed motion password as an argument and produces a motion password shadow. The motion password shadow 370 is stored so it can later be used to authenticate a user.

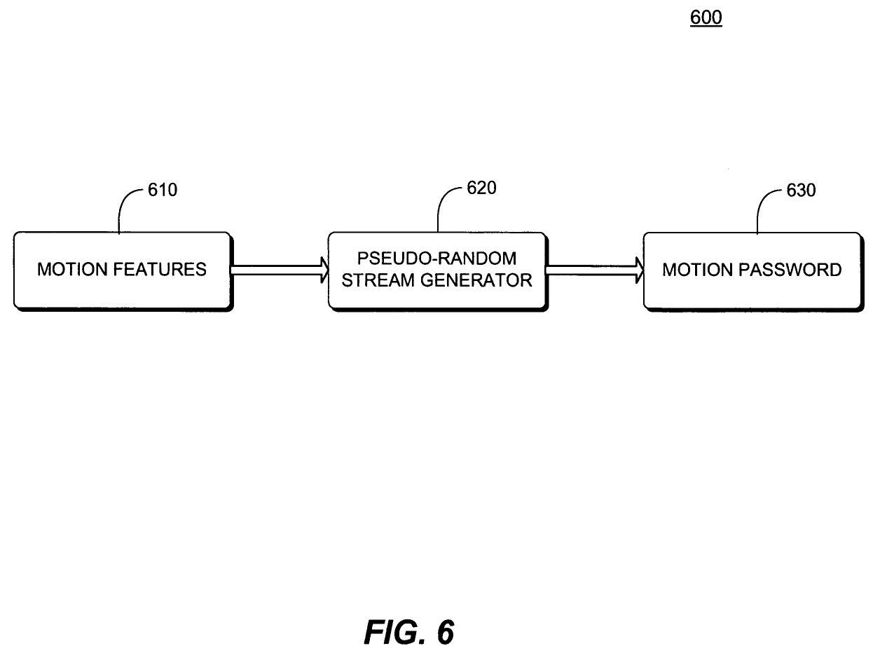

FIG. 6 is a flowchart of an alternative method 600 for generating a motion password from extracted and corrected motion features in accordance with a possible embodiment of the invention. In method 300, the motion password 350 was generated in a recognition session from motion features that were error corrected with stored parity bits derived from a learning session. The parity bits are used to correct for minor variations in the movement of the device during the recognition session. In method 500, the motion password in a learning session is generated from the raw motion signals. The method begins with action 610 where motion features are extracted from the motion of a device. As noted earlier the motion features represent vectors that describe the motion of the device along N degrees of freedom such as x, y, and z. The motion features from action 610 are then used in action 620 to produce a pseudo-random data stream. The pseudo-random stream generator 620 performs an operation on each motion feature, each number in the resultant operation is a random number within a predetermined set of numbers that has an equal probability of being generated by pseudo-random stream generator 620. In action 630, the pseudo-random data stream is assembled to produce a motion password based on the motion of the device.

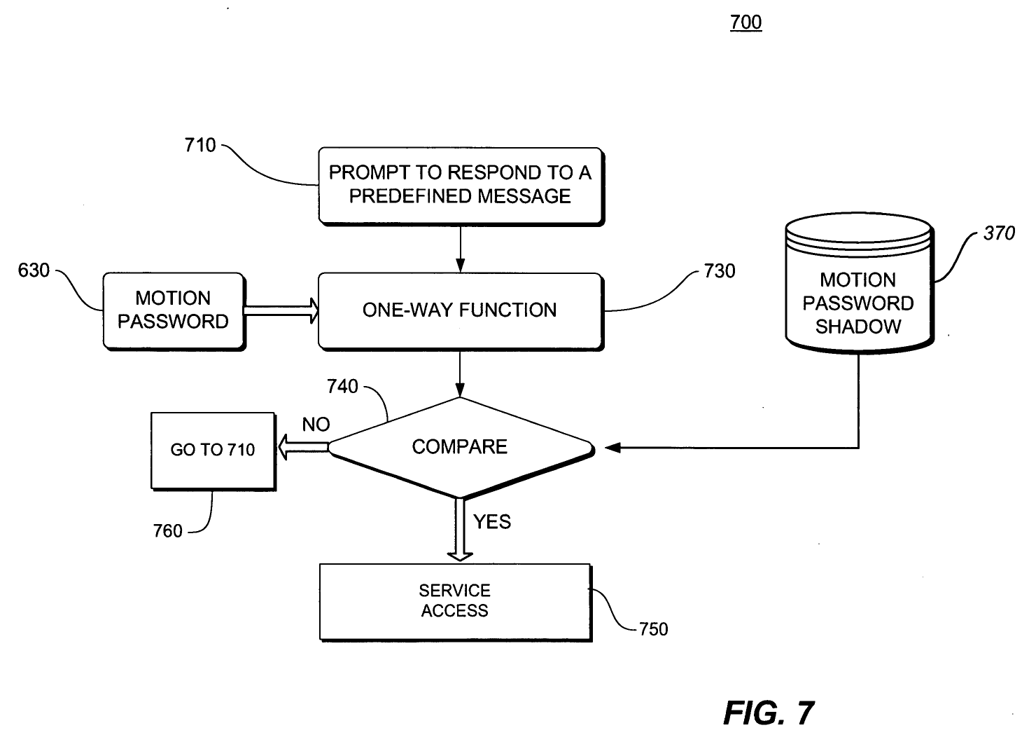

FIG. 7 is a flowchart of method 700 for verifying a user before permitting access to a service in accordance with a possible embodiment of the invention. Method 700 begins with action 710. A predefined message is displayed to the user of the device. The predefined message can be a prompt to draw a unique motion trace that can be used as the password. Method 700 illustrates the case where the prompt is to ask for the user's motion password or for a segment of the user's motion password. It is foreseeable, however, that other responses can be solicited from the user if there is a shadow of the response in storage. In action 630, the response to the predefined message is captured as a series of motion patterns along N degrees of freedom. The motion password 630 and the prompt to respond to a predefined message 710 are subjected to a one-way function. The one-way function combines the predefined message and the motion password 630 to generate a motion password shadow. The output of the one-way function 730 and the pre-stored motion password shadow 370 are compared so to decide whether the user is verified to have access to a service. If the comparison indicates a difference between the response to the predefined message and the stored motion password shadow control is passed to action 760 for further processing. If the comparison indicates a coincidence or a match of the response to the predefined message and the stored motion password shadow control passes to action 750 for further processing. In action 750, the user is granted access to the service.

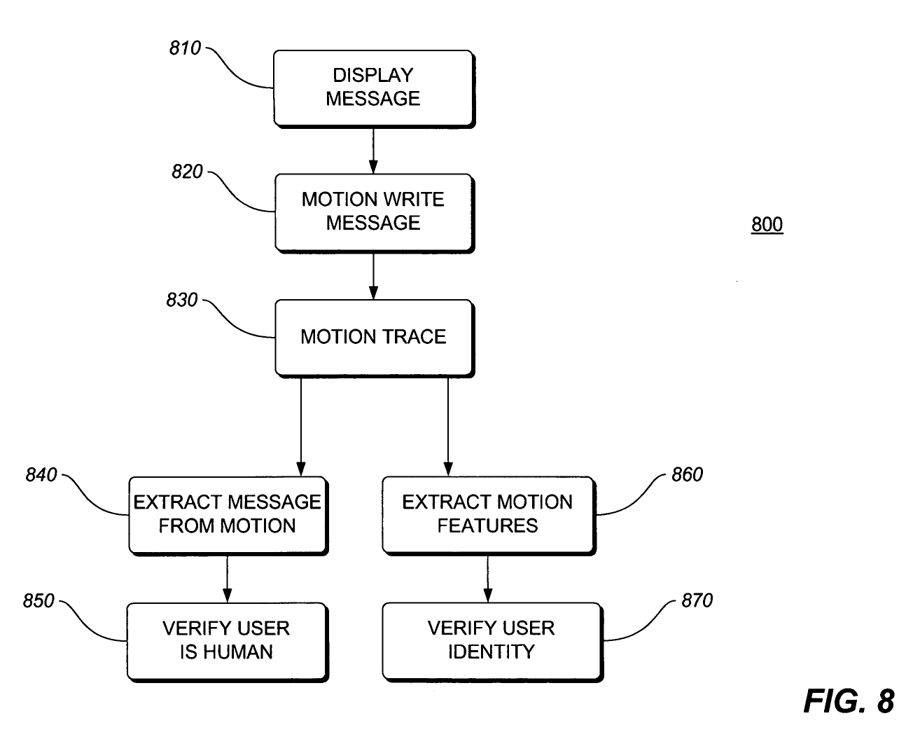

FIG. 8 is a flowchart of method 800 to provide biometric hardened password verification in accordance with a possible embodiment of the invention. In addition to authenticating the password itself, the service can also verify the identity of the user by checking the presence of unique features within the user's motion writing. This solution improves the overall security strength of a password based authentication system. A user trying to impersonate another mobile user not only has to guess the password correctly, but also has to perfectly imitate the motion style corresponding to the motion password. Furthermore, many Internet services require verification of whether a remote user is present or not through application of the Turing test. This type of Turing test plays a critical role in many networked services and applications. For example, when there is an advertisement associated with a mobile service, the service provider wants to make sure the remote user is really a human instead of a program. This type of Turing test can also be used to address spam and service abuse problems faced by many Internet service providers. A standard approach of determining whether or not a user is human is the Completely Automated Public Turing test to Tell Computers and Humans Apart (CAPTCHA). A common type of CAPTCHA requires that the user types the letters of a distorted image, sometimes with the addition of an obscured sequence of letters or digits that appears on the screen. CAPTCHAs are widely used to prevent automated software from performing actions which degrade the quality of service of a given system. Often CAPTCHA and user identity verification are performed separately where CAPTCHA verifies whether a remote user is present or not and user authentication verifies who the user is. If a system needs to perform both tests on a mobile user, the device performs an Authentication and Presence (AP) test to verify that the user is who he or she claims to be, and the CAPTCHA test to verify that the user is not a machine.

Method 800 describes a unified way where a service can perform CAPTCHA and user identity verification, AP test, in one round using motion handwriting traces captured by motion sensors integrated with a mobile device. The benefit is a simplified login process for services that require both a CAPTCHA test and user identity verification. The fact is that given the information stored on the phone such as motion password parity bits and motion password shadow, an attacker cannot reconstruct the motion patterns of the device's owner. This is because during the learning session or initialization phase the system stores only a (noninvertible) one-way function of the motion password and its error-correcting bits.

Method 800 begins with action 810 where a service can require a mobile user to motion write a display message such as letters and digits of a distorted image or an obscured sequence of letters and digits appearing on the screen of the mobile device. The motion write message of the user is captured at action 820 in response to the display message. The uniqueness of an individual's motion writing style allows the service to verify user identity and at the same time differentiate the user from a machine. After collecting motion traces in action 830, the service can run pattern recognition to extract the digit/letter sequence in action 840. The service can authenticate whether or not the user is present by comparing the extracted letter and digit sequence with the letter and digit sequence embedded into the image presented to the mobile user (CAPTCHA) in action 850. In addition, the service can verify the identity of the user by performing a motion writing based biometric identification test. This involves extracting an individual's distinguishing features from the captured motion writing traces in action 860 and judging in action 870 whether the features are sufficient to make a decision on the identity of the mobile user. The detailed process of how motion writing traces captured by a mobile device are converted into a binary decision on whether a mobile user is who he or she claims to be is implementation dependent. There are several standard pattern recognition approaches that can be used by a processor coupled to a motion detection device and a storage device coupled to the processor having a set of instructions in the storage device wherein the processor executes the set of instructions to perform actions such as described in methods 300-800. A general approach in motion verification is to follow some or all the steps of: 1) take a motion writing trace captured by motion sensors integrated with a mobile device; 2) apply pre-processing on the captured data such as filter processing, data cleanup, and calibration; 3) feed the data into a motion classifier that verifies the motion writing trace; 4) convert the classification results into a decision of accepting or rejecting the claimed user. There are many exemplary classifiers that can be used in the process such as neural networks, sequential classifiers, and the like.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, et cetera, that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

In particular, one of skill in the art will readily appreciate that the names of the methods and apparatus are not intended to limit embodiments. Furthermore, additional methods and apparatus can be added to the components, functions can be rearranged among the components, and new components to correspond to future enhancements and physical devices used in embodiments can be introduced without departing from the scope of embodiments. One of skill in the art will readily recognize that embodiments are applicable to future communication devices, different file systems, and new data types. Accordingly, the appended claims and their legal equivalents should only define the invention, rather than any specific examples given.

We claim:

1. An authentication method, the authentication method comprising:
pre-storing motion password parity bits and a motion password shadow from motion captured in a learning session;
constructing a motion password from motion captured during a recognition session and the pre-stored motion password parity bits; and
comparing the constructed motion password with the pre-stored motion password shadow to authenticate a user;
wherein a user is authenticated when the comparison of the constructed motion password with the pre-stored motion password shadow results in a match.

2. The authentication method of claim 1, wherein pre-storing motion password parity bits comprises:
detecting during a learning session motion of a device within N degrees of freedom, with N being an integer greater than or equal to one but less than or equal to six;
extracting motion features from the detected motion of the device;
generating motion password parity bits from the extracted motion features; and
storing the generated motion password parity bits.

3. The authentication method of claim 1, wherein pre-storing a motion password shadow comprises:
detecting during a learning session motion of a device within N degrees of freedom, with N being an integer greater than or equal to one but less than or equal to six;
extracting motion features from the detected motion of the device;
constructing a motion password from the extracted motion features;
transforming the constructed motion password to a motion password shadow; and
storing the motion password shadow.

4. The authentication method of claim 1, wherein constructing a motion password comprises:
detecting during a recognition session motion of a device within N degrees of freedom, with N being an integer greater than or equal to one but less than or equal to six;
extracting motion features from the detected motion of the device; and
performing error correction on the extracted motion features.

5. The authentication method of claim 4, wherein performing error correction comprises correcting the extracted motion features with the motion password parity bits.

6. The authentication method of claim 4, wherein motion of the device is in response to a challenge displayed on a screen on the device.

7. The authentication method of claim 1, the method further comprising:
deleting the constructed motion password when access is granted.

8. An electronic device comprising:
a motion detection device capable of detecting motion of the electronic device within N degrees of freedom, with N being an integer greater than or equal to one but less than or equal to six;
a processor coupled to the motion detection device;
a storage device coupled to the processor;
a set of instructions in the storage device, wherein the processor executes the set of instructions to perform actions that include:
pre-storing motion password parity bits and a motion password shadow from motion captured in a learning session;
constructing a motion password from motion captured during a recognition session and the pre-stored motion password parity bits; and
comparing the constructed motion password with the pre-stored motion password shadow to authenticate a user of the electronic device;
wherein a user is authenticated when the comparison of the constructed motion password with the pre-stored motion password shadow results in a match.

9. The electronic device of claim 8, wherein when pre-storing motion password parity bits the processor executes the set of instructions to perform additional actions that include:
detecting during a learning session motion of the electronic device within N degrees of freedom, with N being an integer greater than or equal to one but less than or equal to six;
extracting motion features from the detected motion of the electronic device;
generating motion password parity bits from the extracted motion features; and
storing the generated motion password parity bits.

10. The electronic device of claim 8, wherein when pre-storing a motion password shadow the processor executes the set of instructions to perform additional actions that include:
detecting during a learning session motion of the electronic device within N degrees of freedom, with N being an integer greater than or equal to one but less than or equal to six;
extracting motion features from the detected motion of the electronic device;
constructing a motion password from the extracted motion features;
transforming the constructed motion password to a motion password shadow; and
storing the motion password shadow.

11. The electronic device of claim 8, wherein when constructing a motion password the processor executes the set of instructions to perform additional actions that include:
detecting during a recognition session motion of the electronic device within N degrees of freedom, with N being an integer greater than or equal to one but less than or equal to six;
extracting motion features from the detected motion of the electronic device; and
performing error correction on the extracted motion features.

12. The electronic device of claim 11, wherein performing error correction comprises correcting the extracted motion features with the motion password parity bits.

13. The electronic device of claim 8, wherein motion of the electronic device is in response to a challenge displayed on a screen on the electronic device.

14. The electronic device of claim 8, wherein the processor executes the set of instructions to perform actions that further include:
deleting the constructed motion password when access is granted.

15. A computer program to authenticate a user, the computer program embodied in a computer readable medium and operable when executed to perform the steps of:
pre-storing motion password parity bits and a motion password shadow from motion captured in a learning session;
constructing a motion password from motion captured during a recognition session and the pre-stored motion password parity bits; and
comparing the constructed motion password with the pre-stored motion password shadow to authenticate a user of a handheld device;
wherein a user is authenticated when the comparison of the constructed motion password with the pre-stored motion password shadow results in a match.

16. The computer program of claim 15, further operable when executed to perform the steps of pre-storing motion password parity bits:
detecting during a learning session motion of the handheld device within N degrees of freedom, with N being an integer greater than or equal to one but less than or equal to six;
extracting motion features from the detected motion of the handheld device;
generating motion password parity bits from the extracted motion features; and
storing the generated motion password parity bits.

17. The computer program of claim 15, further operable when executed to perform the steps of pre-storing a motion password shadow:
detecting during a learning session motion of the handheld device within N degrees of freedom, with N being an integer greater than or equal to one but less than or equal to six;
extracting motion features from the detected motion of the handheld device;
constructing a motion password from the extracted motion features;
transforming the constructed motion password to a motion password shadow; and
storing the motion password shadow.

18. The computer program of claim 15, further operable when executed to perform the steps of constructing a motion password:
detecting during a recognition session motion of the handheld device within N degrees of freedom, with N being an integer greater than or equal to one but less than or equal to six;
extracting motion features from the detected motion of the handheld device; and
performing error correction on the extracted motion features.

19. The computer program of claim 18, wherein performing error correction comprises correcting the extracted motion features with the motion password parity bits.

20. The computer program of claim 15, further operable when executed to perform the steps of:
deleting the constructed motion password when access is granted;
wherein motion of the handheld device is in response to a challenge displayed on a screen on the handheld device.
